(19) United States
(12) Patent Application Publication
(10) Pub. No.: US 2025/0110712 A1
(43) Pub. Date: Apr. 3, 2025

(54) AUTOMATED GENERATIONOF MODELS OF COMPUTATION, SUCH AS PUSHDOWN AUTOMATA, STATE MACHINES, OR PETRI NETS

(71) Applicant: Robert Bosch GmbH, Stuttgart (DE)

(72) Inventors: Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Stuttgart (DE)

(21) Appl. No.: 18/887,255

(22) Filed: Sep. 17, 2024

(30) Foreign Application Priority Data
Sep. 28, 2023 (EP) 23200610.6

(51) Int. Cl. G06F 8/35; G06F 11/3604

(52) U.S. Cl. CPC G06F 8/35; G06F 11/3612

(57) ABSTRACT

A computer-implemented method for the automated generation of a model of computation. The method includes generating, via a machine learning model, at least one model of computation based at least on a specification that the at least one model of computation is to fulfill, and a prompt; and evaluating the at least one model of computation, resulting in an evaluation result. A computer-implemented method for further training a machine learning model, wherein the machine learning model is designed to generate at least one model of computation is also described. The method includes adapting the machine learning model at least based on at least one model of computation and at least one evaluation result, wherein the at least one evaluation result results from evaluating the at least one model of computation.

### BACKGROUND INFORMATION

Embedded software is used for controlling, regulating, and/or monitoring technical systems, in particular cyber-physical systems, such as computing units of a vehicle and/or a robot. In certain cases, the dynamics of such technical systems can be fully or partially represented by a model of computation. The model of computation can in turn be translated into executable code, which is then executed on one or more computing units (e.g. control units) to control, regulate, and/or monitor the technical system.

The term “model of computation” can be understood in the sense of the English term “model of computation”. With regard to computability and/or computational complexity, a model of computation can thus be seen as a model that first describes how one or more output variables of an algorithm are computed given one or more input variables. Furthermore, the model can also describe how the one or more computing units, the memory, and/or the communication are organized.

For example, models of computation can be divided into sequential, functional, and concurrent models. Examples of sequential models are pushdown automata and state machines (which are more specialized than pushdown automata). A concurrent model can be for example a Petri net. In particular, pushdown automata, state machines, and/or Petri nets (but also other models of computation) can be translated into executable code that is designed to control, regulate, and/or monitor the technical system.

With regard to the translation into executable code, which is to be executed on control units, for example-i.e., the executable code then becomes embedded software-the model of computation must already be created according to a specification of the technical system. Depending on the technical system, this specification can have a high degree of complexity and can also change frequently over a product development process (development, testing, production, and maintenance) that can last several years. Because of this, it is challenging for individual software engineers and even for entire software development departments to maintain an overview of the specification and to always adapt the associated model of computation accordingly. This is all the more true since models of computation have so far been created, expanded, corrected, and/or maintained predominantly manually or with only a low degree of automation, i.e. by software engineers. Since this is very time-consuming, costly, and error-prone, a higher degree of automation in the creation of models of computation would be desirable.

The present invention relates to the problem of providing automated but nevertheless reliable models of computation for controlling, regulating, and/or monitoring technical and in particular specified systems.

### SUMMARY

A first general aspect of the present invention relates to a computer-implemented method for the automated generation of a model of computation, in particular a pushdown automaton, a state machine, and/or a Petri net. According to an example embodiment of the present invention, the method comprises generating, via a machine learning model, at least one model of computation based at least on a specification that the at least one model of computation is to satisfy, and a prompt. The method further comprises evaluating the at least one model of computation, resulting in an evaluation result.

The at least one model of computation can be designed to map the controlling, regulation, and/or monitoring of a technical system, in particular a cyber-physical system, in particular at least one computing unit of a vehicle. The method can comprise translating the at least one model of computation into an executable code that is designed to control, regulate, and/or monitor the technical system, in particular the cyber-physical system, in particular the at least one computing unit of the vehicle. The method can be performed in an electronic programming environment.

A second general aspect of the present invention relates to a computer-implemented method for further training a machine learning model, wherein the machine learning model is designed to generate at least one model of computation, in particular a pushdown automaton, a state machine, and/or a Petri net, at least based on at least one specification that the at least one model of computation is intended to fulfill, and a prompt. According to an example embodiment of the present invention, the method comprises adapting the machine learning model at least based on at least one model of computation and at least one evaluation result, wherein the at least one evaluation result results from evaluating the at least one model of computation. The method according to the second general aspect (or an embodiment) can be, but need not be, carried out according to the method according to the first general aspect (or an embodiment thereof).

A third general aspect of the present invention relates to a computer system that is designed to carry out the computer-implemented method for the automated generation of a model of computation, in particular a pushdown automaton, a state machine, and/or a Petri net, according to the first general aspect (or an embodiment thereof) and/or the computer-implemented method for further training a machine learning model according to the second general aspect (or an embodiment thereof).

A fourth general aspect of the present invention relates to a computer program that is designed to carry out the computer-implemented method for the automated generation of a model of computation, in particular a pushdown automaton, a state machine, and/or a Petri net, according to the first general aspect (or an embodiment thereof) and/or the computer-implemented method for further training a machine learning model according to the second general aspect (or an embodiment thereof).

A fifth general aspect of the present invention relates to a computer-readable medium or signal that stores and/or contains the computer program according to the fourth general aspect (or an embodiment thereof).

A method provided in the present disclosure according to the first aspect (or an embodiment thereof) of the present invention is directed to the automated generation of at least one model of computation. Thanks to the high degree of automation, the at least one model of computation can be adapted more quickly and more frequently but at the same time reliably, in particular to a frequently changing specification of the technical system.

This is achieved on the one hand by the machine learning model with a sufficiently large understanding of machine language, in particular with regard to the specification, and on the other hand by the automated evaluation of the at least one model of computation according to established V & V methods. For example, the at least one created model of computation can be verified against a formal specification. This makes it possible to utilize the machine learning model's creativity while at the same time ensuring the quality of the at least one model of computation. In other words: Errors, especially incomplete or faulty models of computation, which can occasionally arise from the machine learning model, are detected reliably, or at least with a sufficiently high probability, by the V & V methods before they are translated into executable code and used to control, regulate, and/or monitor the technical system, such as a vehicle or a robot. This also improves the technical system. At least a correctness and/or a probability of correctness can be output via the evaluation result. If the evaluation result is not satisfactory, the method can be repeated and, optionally, the prompt can be adapted to expand, improve, and/or correct at least one model of computation. Advantageously, even in the case of an unsatisfactory evaluation result a counterexample can be output that violates the specification. In a further iteration of the method, a model of computation can then be generated again, optionally with an adapted prompt, which is intended in particular to prevent this counterexample. If necessary, manual intervention is always possible, e.g. via the electronic programming environment, and the at least one model of computation can be adapted accordingly.

Furthermore, thanks to automation and efficiency, it is also possible to generate a (large) multiplicity of models of computation. These can be of the same type (e.g. only state machines) or of different types. A model of computation can then be selected that best meets the specification. Information about this can be output in the evaluation result.

In the case of a contradictory specification, the evaluation result can indicate that it was not possible to generate a model of computation. In this respect, the specification can also be efficiently checked for contradictions.

A further advantage is that the resulting models of computation can be used to train a domain-specific generator for models of computation. This can be done, for example, as in the method 200 according to the second general aspect (or an embodiment thereof). This allows supervised fine-tuning and/or unsupervised (reinforcement) learning to be performed based on the evaluation results, thus improving the method according to the first general aspect (or an embodiment thereof). This will enable (future) models of computation to be better generated.

### BRIEF DESCRIPTION OF THE DRAWINGS

FIG. 1 schematically illustrates exemplary embodiments of a computer-implemented method for the automated generation of a model of computation, in particular a pushdown automaton, a state machine, and/or a Petri net, according to the present invention.

FIG. 2 schematically illustrates exemplary machine learning models that map at least specification and prompt to at least one model of computation, according to the present invention.

FIG. 3 schematically illustrates the evaluation of the at least one model of computation, according to the present invention.

### DETAILED DESCRIPTION OF EXAMPLE EMBODIMENTS

The method 100 according to the present invention proposed in the present disclosure is directed to the automated generation of models of computation, in particular pushdown automata, state machines, and/or Petri nets. Since machine learning models sometimes produce incorrect results, the generated models of computation must be validated and verified (V & V) before their translations as executable code are used as embedded software to control, regulate, and/or monitor a technical system.

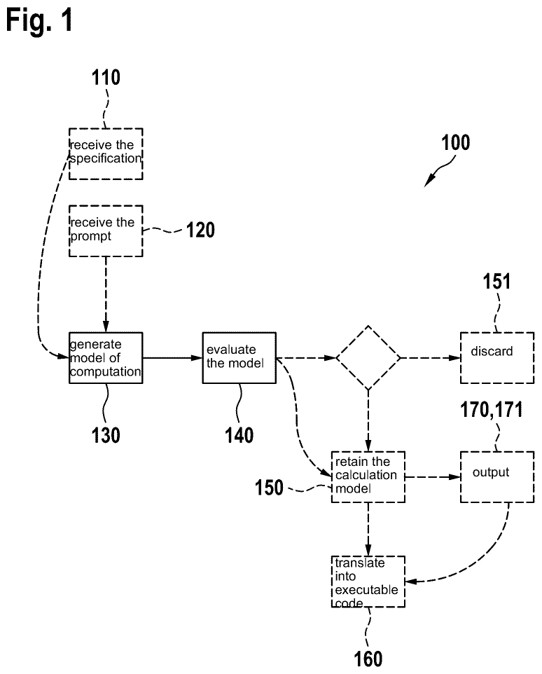

First, a computer-implemented method 100 is disclosed, schematically illustrated in FIG. 1, for the automated generation of a model of computation, in particular a pushdown automaton, a state machine, and/or a Petri net. The method 100 includes generating 130, via a machine learning model 30, at least one model of computation 40 based at least on a specification 10 that the at least one model of computation 40 is to satisfy, and a prompt 20. The method 100 further comprises evaluating 140 the at least one model of computation 40, resulting in an evaluation result.

The at least one model of computation 40 can be formal. For example, the at least one model of computation 40 can include or be a data structure written in a predetermined syntax and/or predetermined grammar (e.g. in a programming language). The at least one model of computation 40 can be executable code. On the other hand, the at least one model of computation 40 need not be executable code, but can instead be designed to be translated 160 into executable code.

The at least one model of computation 40 can comprise or be a sequential model. For example, the at least one model of computation 40 can comprise an automaton or can be an automaton. In particular, the at least one model of computation 40 can comprise a pushdown automaton or be a pushdown automaton. In particular, the at least one model of computation 40 can comprise a state machine (i.e. a finite state machine) or can be a state machine.

Alternatively or additionally, the at least one model of computation 40 can comprise or be a concurrent model. For example, the at least one model of computation 40 can comprise or be a Petri net.

In the case of a pushdown automaton, a state machine, and/or a Petri net, problems are decidable. This decidability can be used to check whether the at least one model of computation 40 satisfies the specification 10. A model checker can be used for this purpose. On the other hand, problems do not necessarily have to be decidable in the at least one model of computation, since it can also be checked by (external) testing whether the at least one model of computation 40 fulfills the specification 10. In (external) testing, for example, one or more input variables can be specified and one or more resulting output variables can be evaluated with respect to the specification 10. This also allows at least one model of computation 40 to be validated and/or verified.

In particular, a computer-implemented method 100 for the automated generation of a pushdown automaton is disclosed. Here, the at least one model of computation 40 is therefore a pushdown automaton. The method 100 includes generating 130, via a machine learning model 30, at least one pushdown automaton based at least on a specification 10 that the at least one pushdown automaton is to fulfill, and a prompt 20. The method 100 further comprises evaluating 140 the at least one pushdown automaton, resulting in an evaluation result.

In particular, a computer-implemented method 100 for the automated generation of a state machine is disclosed. Here, at least one model of computation 40 is therefore a state machine. The method 100 includes generating 130, via a machine learning model 30, the at least one state machine based at least on a specification 10 that the at least one state machine should fulfill, and a prompt 20. The method 100 further comprises evaluating 140 the at least one state machine, resulting in an evaluation result.

In addition, a computer-implemented method 100 for the automated generation of a Petri net is disclosed. Here the at least one model of computation 40 is therefore a Petri net. The method 100 includes generating 130, via a machine learning model 30, the at least one Petri net based at least on a specification 10 that the at least one Petri net should satisfy, and a prompt 20. The method 100 further comprises evaluating 140 the at least one Petri net, resulting in an evaluation result.

More generally, the at least one model of computation 40 or the models of computation can comprise a pushdown automaton, a state machine, and/or a Petri net.

The evaluation result can include a natural-language text or can be such a natural-language text. Alternatively or additionally, the evaluation result can comprise a data structure written in a predetermined syntax (e.g. in a programming language), or can be such a data structure. The data structure can for example include the natural-language text. The evaluation result can comprise one or more numerical values, in particular one or more confidence values. As a result, a quality of the at least one model of computation 40 (e.g. of the at least one pushdown automaton, the at least one state machine, or the at least one Petri net) can be encoded, which can be taken into account in the validation and verification of the at least one model of computation 40, and thus of the technical system represented by the at least one model of computation 40. The evaluation 140 of the at least one model of computation 40 can be seen as a validation and/or as a verification (V & V).

If it is not possible to generate a model of computation that meets the specification, the evaluation result can include an item of information stating that the generation of the at least one model of computation has failed. This can happen for example if the specification itself is already contradictory. This information is also valuable for the development of the technical system. In this case, the specification can and must be adapted and, in particular, improved.

The method 100 can include receiving 110 the specification 10. Alternatively or additionally, the method 100 can include receiving 120 the prompt 20. Alternatively or additionally, the method 100 can include receiving the machine learning model 30.

As shown schematically in FIG. 3, for example, the at least one calculation model can be evaluated, wherein, for example, in each case the results OK or nO (short for: not OK) are included in the evaluation result. In the case of a nOK result, the at least one model of computation can be repaired (“fixed”), wherein a model of computation generated in an earlier iteration of the method 100 can for example be adapted, improved, and/or corrected in a further iteration of the method 100.

The specification 10 can include a natural-language description or can be such a description. The natural-language description can be or include a text that describes the desired behavior and/or the desired properties of the at least one model of computation to be generated 130 (e.g. the pushdown automaton, the state machine, and/or the Petri net). Alternatively or additionally, the specification 10 can include a formal description, or can be such a description. A formal specification can, for example, include or be based on a formal language that represents desired sequences of behavior of the technical system.

The natural-language and/or formal specification 10 of the at least one model of computation 40 can for example comprise one or more validity ranges for parameters of the at least one model of computation 40. Alternatively or additionally, the natural-language and/or formal specification 10 can, for example, comprise a description of the (desired) functionality of the at least one model of computation 40. Alternatively or additionally, the natural-language and/or formal specification 10 can, for example, include the purpose to be achieved by the at least one model of computation 40.

The machine learning model 30 can comprise or be a foundation model. A foundation model can be a large machine learning model that has been trained on a large dataset at scale (often through self-supervised learning or semi-supervised learning) so that it can be adapted to a wide range of downstream tasks. In particular, the machine learning model can comprise or be a large language model (LLM). A large language model can be a language model that is characterized by its size. In particular, the large language model can be a chatbot or have chatbot functionality.

Google BERT, for example, can be used as a large language model. Alternatively or additionally, for example, OpenAI's ChatGPT (e.g. in the version of May 24, 2023) can be used as a large language model. Alternatively or additionally, for example, Hugging Face Bloom can be used as a large language model.

Alternatively or additionally, the machine learning model can comprise or be a multi-domain model. For example, OpenAI's GPT-4 (e.g. the version of Mar. 14, 2023) can be used here.

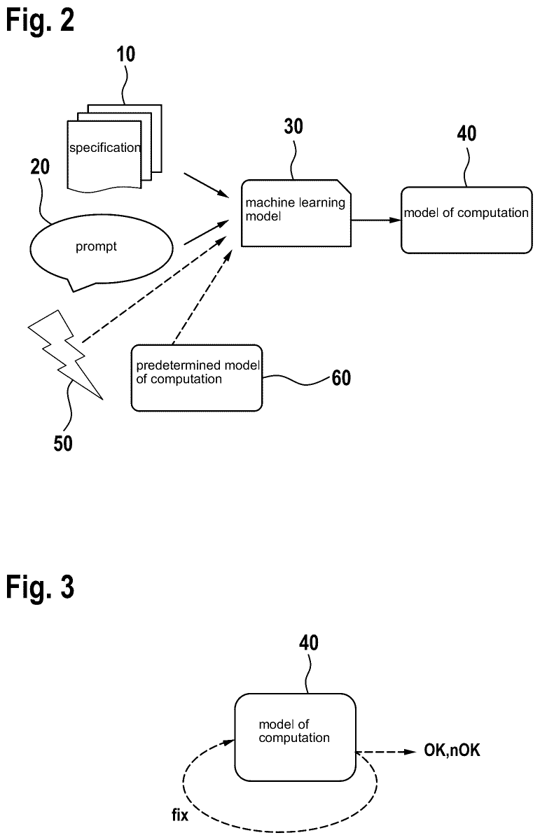

Exemplary embodiments of the machine learning model 30 are illustrated schematically in FIG. 2.

The prompt 20 can be a natural-language text. The prompt 20 can include or be a natural-language instruction to the machine learning model 30. The prompt can, for example, comprise a linguistic instruction to the Large Language Model (LLM) to generate one or more models of computation based on the specification 10. For example, it can be specified that the models of computation should include a pushdown automaton. Alternatively or additionally, it can be specified that the models of computation should include a state machine. Alternatively or additionally, it can be specified that the models of computation should include a Petri net. In particular, it can be specified that the models of computation should include a pushdown automaton, a state machine, and/or a Petri net.

Alternatively or additionally, the prompt can comprise a linguistic instruction to the Large Language Model (LLM) to generate one or more models of computation in which the at least one counterexample 50 that violates the specification 10 does not occur. Here too, as already discussed, it can be specified that the models of computation should include a pushdown automaton, a state machine, and/or a Petri net.

Alternatively or additionally, the prompt can comprise a linguistic instruction to the Large Language Model (LLM) to generate one or more models of computation that expand, improve, and/or correct the predetermined model of computation 60.

Generating 130 the at least one model of computation 40 can include generating a plurality of models of computation. The method 100 can in particular comprise generating 130 a plurality of models of computation (i.e. at least two models of computation) based at least on the specification 10 and the prompt 20 (or multiple prompts). For example, one or more models of computation of the plurality of models of computation can be generated at least based on the specification 10 and the prompt 20, i.e. in a (single) execution of the method 100. Alternatively or additionally, one or more models of computation of the plurality of models of computation can be generated 130 by multiple executions of the method 100. Advantageously, in multiple executions of the method 100 the prompt 20 can be varied. On the other hand, the prompt 20 need not be varied in multiple executions of the method 100. Alternatively or additionally, one or more of the plurality of models of computation can be predetermined. Alternatively or additionally, the machine learning model can be varied in multiple executions of the method 100.

The plurality of models of computation can include models of computation of different types. For example, the plurality of models of computation can include one or more state machines, one or more pushdown automata, and/or one or more Petri nets. By evaluating the models of computation, it can then be output, for example, how the properties and/or behavior of the technical system desired according to the specification 10 can best be mapped. This model of computation can then be selected.

The at least one model of computation 40 can be designed to map the control, regulation, and/or monitoring of a technical system, in particular a cyber-physical system, in particular at least one computing unit of a vehicle.

The natural-language and/or formal specification 10 can, for example, describe how the technical system, in particular the cyber-physical system, in particular the at least one computing unit of the vehicle, is to be controlled, regulated, and/or monitored. The natural-language and/or formal specification 10 can, for example, define which property, which state, and/or which behavior of the technical system is undesirable and is to be prevented. Examples of this can be: “State ‘ERROR’ should never be reached” and/or “Part A and Part B should never be in the state ‘REQUEST GRANTED’ at the same time”. Furthermore, one part of the specification 10 can be an exclusion of e.g. deadlocks. By excluding deadlocks, it is possible to prevent two or more recipients from having to wait too long (i.e. indefinitely) for a response. Other combinations of models of computation and (formal) specifications are also possible.

A model of computation can be used, for example, to illustrate how hardware is controlled. A model of computation can also represent, for example, one or more protocols in the area of the Internet of Things (IoT).

A model of computation can be a model of the behavior and/or properties of the technical system, in particular the cyber-physical system, in particular of the at least one computing unit of the vehicle. The model can include states, state transitions, and/or actions, as in the case of the state machine, for example. A state can contain an item of information about the past, in particular since the technical system has reached the state on its previous path, i.e. the state can to some extent reflect the changes in the input from an earlier point in time (e.g. since the system start) to the current point in time. A state transition can be a transition from the current state to a new (different) state. This transition can occur if the specified logical conditions/“inputs” are present that must be met in order to enable the transition. An action can be the “output” of the model of computation that occurs in a particular situation. For example, there can be four types of actions: entry action, exit action, input action, and transition action. An entry action can be an action that is executed/output when entering a state (regardless of which state transition the state was reached by, if there are more than one). An exit action can be an action that is generated when leaving a state (regardless of the state transition by which the state is left). An input action can be an action that is generated depending on the current state and the input. A state can therefore be assigned a plurality of actions that are executed depending on which state transition was used to reach/leave it. A transition action can be an action that is performed depending on/during a state transition.

The method 100 can include translating 160 the at least one model of computation 40 into an executable code that is designed to control, regulate, and/or monitor the technical system, in particular the cyber-physical system, in particular the at least one computing unit of the vehicle.

The 16urther16eon 160 of the at least one model of computation 40 into the executable code can, but does not have to, be realized via another machine learning model 30. On the other hand, the translation 160 may be unnecessary, in particular if the generated 130 at least one model of computation 40 is already an executable code. This is because this code can be designed to control, regulate, and/or monitor the technical system, in particular the cyber-physical system, in particular the at least one computing unit of the vehicle. In other words, the already executable model of computation, or the model of computation translated 160 into executable code, can be designed to control, regulate, and/or monitor the technical system. In particular, they can be executed on one or more computing units (e.g. control units) e.g. in the technical system.

Typical examples can be controlling in the automotive sector, such as engine control, control of actuators, diagnostics, and/or protocols in the IoT sector. The created 130 model of computation can be used in particular to automatically generate a control structure which then controls the systems mentioned, e. g. engine control, ABS/brakes, generally widely used in the embedded area to control e.g. actuators.

The method 100 can be performed in an electronic programming environment. The execution and/or multiple executions of the method 100 can be controlled interactively and/or in automated fashion via the electronic programming environment. The electronic programming environment enables programming and/or interaction with a plurality of iterations of the method 100. The electronic programming environment proves to be particularly advantageous when initializing the iterations and/or debugging during the iterations. For example, the prompt 20 and/or the additional prompt 21 can be customized in the electronic programming environment.

In the following, specific factors are disclosed on which the generation of the at least one model of computation may depend.

The generation 130, via the machine learning model 30, of the at least one model of computation 40 can be based at least on a formal specification. Here the specification 10 can comprise the formal specification. For example, the specification 10 can be the formal specification. In another example, the specification 10 can comprise the formal specification. Here for example the specification 10 can additionally include the natural-language description. In another example, the formal specification can be taken into account as further input of the machine learning model 30 when generating 130 the at least one model of computation.

Alternatively or additionally, the generation 130, via the machine learning model 30, of the at least one model of computation 40 can be based on at least one counterexample 50 that violates the specification 10.

A counterexample 50 can, for example, be a behavior of the at least one model of computation that should not occur according to the specification 10 (of the technical system). For example, the specification 10 may prescribe: “After entering the braking state (state B), the brake must first be released (state R) before acceleration can occur (state A)”. A counterexample 50 here would be, for example, a sequence that contains the state sequence B, X, . . . , X, A, without an “R” in between (here all X are not equal to “R”).

The at least one counterexample 50 that violates the specification 10 can, for example, as schematically illustrated in FIG. 2, be taken into account as further input of the machine learning model 30 when generating 130 the at least one model of computation. Alternatively, the at least one counterexample 50 that violates the specification 10 can be included in the generation 130 of the at least one model of computation via the prompt 20. The at least one counterexample 50 violating the specification 10 can be a text. The at least one counterexample 50 violating the specification 10 can, but need not, result from an earlier iteration of the method 100. If necessary, the prompt 20 can also be adapted for the current iteration. For example, the prompt 20 can include a request to improve and/or correct the at least one model of computation in such a way that the counterexample 50 no longer occurs in the generated 130 at least one model of computation.

Alternatively or additionally, the generation 130, via the machine learning model 30, of the at least one model of computation 40 can be based on at least one predetermined model of computation 60. Here the predetermined model of computation 60 can have been generated in an earlier iteration of the method 100. On the other hand, this does not have to be the case.

The predetermined model of computation 60 can, for example, as schematically illustrated in FIG. 2, be taken into account as further input of the machine learning model 30 when generating 130 the at least one model of computation. Alternatively, the predetermined model of computation 60 can be included in the generation 130 of the at least one model of computation via the prompt 20. For example, the predetermined model of computation 60 can be a model of computation generated in a previous iteration of the method 100 that is now to be expanded, improved, and/or corrected in the current iteration of the method 100. If necessary, the prompt 20 can also be adapted for the current iteration. For example, the prompt 20 can include a request to find and correct one or more syntax and/or grammatical errors in the predetermined model of computation 60.

As schematically illustrated for example by the “OK” in FIG. 3, the method 100 can comprise retaining 150 the at least one calculation model 40 according to a predetermined criterion based on the evaluation result. The method 100 can (but does not have to) include discarding 151 the at least one model of computation 40, as schematically illustrated in FIG. 1. Instead of the discarding, the at least one model of computation can for example be repaired; see e.g. FIG. 3. If the at least one model of computation is not retained 150, it, and/or a finding derived from it, can be taken into account in a new iteration of the method 100.

The evaluation 140 of the at least one model of computation can include checking whether the syntax and/or grammar of the at least one model of computation 40 is correct. For example, a simulator for an automaton can be used for this purpose. In other words, the model of computation 40 can be at least partially executed in order to detect, for example, grammatically incorrect outputs in the machine learning model 30. As already discussed, for example the at least one model of computation generated 130 in incorrect syntax and/or incorrect grammar can be used as a predetermined model of computation 60 together with a possibly adapted prompt 20 to generate an expanded, improved, and/or corrected model of computation in a further iteration of the method 100.

Alternatively or additionally, the evaluation 140 of the at least one model of computation 40 can include checking whether a formal specification is met by the at least one model of computation 40. This can be done, for example, using a model checker. The formal specification can, but does not have to, be included in the specification 10, i.e. the formal specification can, but does not have to, be the formal specification on which the creation 130 of the at least one model of computation was based. The method 100 can include receiving the formal specification. In cases where the model of computation is decidable (e.g. in the case of state machines and/or pushdown automata), the model checker can be used to check whether the formal specification is met. The method can in particular comprise setting up a verification environment.

The method 100 can include outputting a counterexample 50 if the check reveals that the formal specification is not met by the at least one model of computation 40. As already discussed, for example the counterexample 50 can be used together with a possibly adapted prompt 20 to generate an expanded, improved, and/or corrected model of computation in a further iteration of the method 100.

Evaluating 140 the at least one model of computation 40 can include evaluating the plurality of models of computation. For example, one or each model of computation of the plurality can be evaluated with regard to its complexity. Alternatively or additionally, it can be checked whether the syntax and/or grammar of one or each model of computation of the plurality is correct, optionally via the simulator for an automaton in each case. Alternatively or additionally, it can be checked whether the formal specification is met by one or each model of computation of the plurality. In cases where the formal specification is not met by one or each model of computation of the plurality, one or more counterexamples 50 can be output in each case.

Alternatively or additionally, evaluating the plurality of models of computation can comprise selecting a model of computation from the plurality of models of computation according to a predetermined criterion. Here the selected model of computation can be the at least one generated 130 model of computation 40. The predetermined criterion can, for example, be designed such that in the event that none of the models of computation in the plurality satisfies the formal specification, the (so far) best model of computation, i.e. for example the model of computation that least violates the formal specification, is selected. This model of computation and at least one associated counterexample 50 can be used together with a possibly adapted prompt 20 in further iteration of the method 100 to generate a better model of computation.

The method 100 can include outputting 170 the evaluation result. This can be done, for example, via the electronic programming environment. This is advantageous because the sequence of the method 100 can be adapted based on the evaluation result. For example, models of computation can be manually selected or rejected based on the evaluation results.

Alternatively or additionally, the method 100 can include outputting 171 the at least one model of computation 40. This can also be done for example via the electronic programming environment.

The method 100 can be based on at least one input from a user of an interface of the electronic programming environment. For example, the method 100 and/or its multiple executions can be (interactively) controlled via the electronic programming environment. This can be helpful, for example, in setting up the programming environment and/or the execution environment before the method 100 is run in automated fashion. Alternatively or additionally, the interactive control can be helpful in debugging the automated running of the method 100.

The method 100 can be repeated. The machine learning model and/or the prompt, as well as further inputs if necessary, can be varied. If necessary, for example if the evaluation result of at least one model of computation is not sufficiently good, in at least one further iteration additional models of computation can be generated, in particular to expand, improve, and/or correct the models of computation generated so far. For example, the previous models of computation can be used as additional input.

Different models of computation can be generated by both single and multiple executions of the method 100. Even in a single execution of the method 100, a variance exists due to the inherent variability of the machine learning model (temperature). For example, if 101 different models of computation based on a prompt are supposed to be generated, 101 different models of computation may actually be generated due to the inherent variability. Furthermore, there is variance in multiple executions of the method 100 due to the possible multiplicity of prompts. Alternatively or additionally, variance exists due to different combinations of different input artifacts (e.g. specification only, with predetermined model of computation, with counterexample, etc.). If statically detectable multiply occurring models of computation are however generated (for example through independent multiple executions), they can be rejected. There may also be a variance in multiple executions of the method 100 due to different specifications.

Also disclosed is a computer-implemented method 200 for further training a machine learning model 30, wherein the machine learning model 30 is designed to generate 130 at least one model of computation 40, in particular a pushdown automaton, a state machine, and/or a Petri net, at least based on at least one specification 10 that the at least one model of computation 40 is intended to fulfill, and a prompt 20. The method 200 includes adapting the machine learning model 30 at least based on at least one model of computation 40 and at least one evaluation result, wherein the at least one evaluation result results from evaluating 140 the at least one model of computation 40.

The evaluation 140 can, but does not have to, be part of the method 200. The at least one model of computation 40 can have been generated 130 and evaluated 140 according to the method 100 for the automated generation of a model of computation 40. The method 200 can, but does not have to, be a continuation of the method 100.

Alternatively or additionally, the method 100 can be executed again via an adapted machine learning model. In particular, the machine learning model 30 can be adapted between multiple executions of the method 100 according to the method 200.

The adaptation of the machine learning model 30 can be based on at least one specification 10 and at least one prompt 20.

The machine learning model 30 can be adapted through supervised learning. Such an adaptation of the machine learning model 30 can be seen as supervised fine-tuning. Thanks to the fine-tuning, a generic machine learning model that has been trained for example to understand general machine language can be adapted to a specific application, i.e. here with regard to generating models of computation.

The fine-tuning of the machine learning model 30 can, but does not have to, precede a further adaptation of the machine learning model 30 through unsupervised (reinforcement) learning.

Alternatively or additionally, adapting the machine learning model 30 at least based on the at least one model of computation 40 and the at least one evaluation result can include calculating at least one reward at least based on the at least one evaluation result, and adapting the machine learning model 30 at least based on the at least one model of computation 40 and the at least one reward. Such an adaptation of the machine learning model 30 can be seen as unsupervised (reinforcement) learning. This allows a generic machine learning model, which has been trained for example to understand general machine language, and/or such a model after fine-tuning, to be (further) adapted in an application-specific manner, i.e. here with regard to the generation of models of computation. This allows the machine learning model 30 to be adapted even better to the use case of generating models of computation.

A reward can be a parameter, in particular a numerical parameter, that is comparable to other parameters that are also rewards. For example, a reward can be greater than, equal to, or less than another reward.

The at least one reward can be larger if the at least one evaluation result is better, and the at least one reward can be smaller if the at least one evaluation result is worse.

An evaluation result can be worse, in particular poor, if a check on which the evaluation result is based has already come out negative, e.g. was failed. Alternatively or additionally, an evaluation result can be better, especially good, if all checks turn out positive, e.g. were passed.

The machine learning model 30 can be adapted based on at least a plurality of models of computation and a plurality of associated rewards. The method can include calculating the rewards based at least on a plurality of evaluation results per model of computation. In other words, the reward for a model of computation need not depend only on its evaluation result, but can also be based on one or more evaluation results for other models of computation. For example, one or more rewards (i.e. how large they are) can depend on a number of evaluation results. Alternatively or additionally, one or more rewards may depend on a number of better evaluation results and on a number of worse evaluation results, in particular on an imbalance between better and worse evaluation results. Alternatively or additionally, rewards can first be calculated per evaluation result and then adjusted and/or offset based on other evaluation results.

Adapting the machine learning model 30 can be based on a reinforcement learning algorithm, such as Proximal Policy Optimization (PPO).

A part of the machine learning model 30 cannot (intentionally) be adapted, i.e. fixed. Here only another part of the machine learning model 30 is adapted.

For example, certain parameters, such as weights and/or biases, in particular weights and/or biases on earlier layers of the machine learning model 30, cannot be adjusted, i.e. fixed. For example, the adaptations can be restricted to rear layers of the machine learning model 30, in which models of computation are worked out. This can ensure that the machine learning model 30 does not deteriorate unduly in terms of machine language comprehension. On the other hand, adaptation can seek to deteriorate the machine language understanding, to the extent that the understanding does not play a role in the generation of models of computation. For example, machine language understanding of Shakespearean English is (usually) not required for generating models of computation.

The method 200 can be controlled via the electronic programming environment. In particular, the machine learning model 30 can be further adapted via the electronic programming environment.

Also disclosed is a computer system which is designed to execute the computer-implemented method 100 for the automated generation of a model of computation, in particular a pushdown automaton, a state machine, and/or a Petri net. Alternatively or additionally, the computer system can be designed to execute the computer-implemented method 200 for further training a machine learning model 30. In particular, the computer system can be designed to execute the computer-implemented method 100 for the automated generation of a model of computation, in particular a pushdown automaton, a state machine, and/or a Petri net, and (e.g. subsequently) the computer-implemented method 200 for further training a machine learning model 30. The computer system can comprise a processor and/or a working memory.

Also disclosed is a computer program which is designed to execute the computer-implemented method 100 for the automated generation of a model of computation, in particular a pushdown automaton, a state machine, and/or a Petri net. Alternatively or additionally, the computer program can be designed to execute the computer-implemented method 200 for further training a machine learning model 30. In particular, the computer program can be designed to execute the computer-implemented method 100 for the automated generation of a model of computation, in particular a pushdown automaton, a state machine, and/or a Petri net, and (e.g. subsequently) the computer-implemented method 200 for further training a machine learning model 30. The computer program can be present, for example, in interpretable or in compiled form. For execution, it can (even in parts) be loaded into the RAM of a computer, for example as a bit or byte sequence.

Also disclosed is a computer-readable medium or signal that stores and/or contains the computer program. The medium can comprise, for example, any one of RAM, ROM, EPROM, HDD, SSD, . . . , on/in which the signal is stored.

1-15. (canceled)

16. A computer-implemented method for automated generation of a model of computation including a pushdown automaton and/or a state machine and/or a Petri net, the method comprising:
generating, via a machine learning model, at least one model of computation based at least on one specification which the at least one model of computation is to fulfill, and based on a prompt; and
evaluating the at least one model of computation, resulting in an evaluation result.

17. The method according to claim 16, wherein the at least one model of computation is configured to map a controlling and/or regulation and/or monitoring of a technical system including a cyber-physical system which includes at least one computing unit of a vehicle.

18. The method according to claim 17, further comprising:
translating the at least one model of computation into an executable code which is configured to control and/or regulate, and/or monitor the technical system.

19. The method according to claim 16, wherein the generation, via the machine learning model, of the at least one model of computation is based at least on at least one counterexample that violates the specification.

20. The method according to claim 16, further comprising:
retaining the at least one model of computation according to a predetermined criterion based on the evaluation result; and
otherwise, optionally discarding the at least one model of computation.

21. The method according to claim 16, wherein the evaluation of the at least one model of computation includes:
checking whether a syntax and/or grammar of the at least one model of computation is correct via a simulator for an automaton.

22. The method according to claim 16, wherein the evaluation of the at least one model of computation includes:
checking whether a formal specification is met by the at least one model of computation via a model checker.

23. The method according to claim 22, further comprising:
outputting a counterexample when the check yields a result that the formal specification is not met by the at least one model of computation.

24. The method according to claim 16, wherein the generating of the at least one model of computation includes generating a plurality of models of computation, wherein the evaluating of the at least one model of computation includes evaluating the plurality of models of computation.

25. The method according to claim 24, wherein the evaluation of the plurality of models of computation includes:
selecting a model of computation from the plurality of models of computation according to a predetermined criterion, wherein the selected model of computation is the at least one generated model of computation.

26. A computer-implemented method for further training a machine learning model, wherein the machine learning model is configured to generate at least one model of computation including a pushdown automaton and/or a state machine and/or a Petri net, at least based on at least one specification that the at least one model of computation is to fulfill, and based on a prompt, the method comprising the following steps:
adapting the machine learning model at least based on at least one model of computation and at least one evaluation result, wherein the at least one evaluation result results from evaluating the at least one model of computation;
wherein the at least one model of computation was generated and evaluated according to a method for automated generation of a model of computation, the method for automated generation of the model of computation including:
generating, via the machine learning model, the at least one model of computation based at least on one specification which the at least one model of computation is to fulfill, and based on a prompt; and
evaluating the at least one model of computation, resulting in the evaluation result.

27. The method according to claim 26, wherein the adaptation of the machine learning model based at least on the at least one specification and the at least one evaluation result includes:
calculating at least one reward based at least on the at least one evaluation result; and
adapting the machine learning model based at least on the at least one specification and the at least one reward.

28. A computer system configured for automated generate of a model of computation, in particular a pushdown automaton, a state machine, and/or a Petri net, the computer system configured to:
generate, via a machine learning model, at least one model of computation based at least on one specification which the at least one model of computation is to fulfill, and based on a prompt; and
evaluate the at least one model of computation, resulting in an evaluation result.

29. A non-transitory computer-readable medium on which is stored a computer program for automated generation of a model of computation including a pushdown automaton and/or a state machine and/or a Petri net, the computer program, when executed by a computer, causing the computer to perform the following steps:
generating, via a machine learning model, at least one model of computation based at least on one specification which the at least one model of computation is to fulfill, and based on a prompt; and
evaluating the at least one model of computation, resulting in an evaluation result.
